(19) United States
(12) Patent Application Publication
(10) Pub. No.: US 2019/0143294 A1
(43) Pub. Date: May 16, 2019

(54) A PROCESS FOR PREPARING METAL OXIDE-BASED CHLORIDE ABSORBENT USING NATURAL BINDER AND PRODUCT OBTAINED THEREFROM

(71) Applicant: PTT Public Company Limited, Chatuchak, Bangkok (TH)

(72) Inventors: Ratanawan KIATTIKOMOL, Chatuchak Bangkok (TH); Somrudee PREDAPITAKKUN, Chatuchak Bangkok (TH); Usawadee MAIKHONG, Chatuchak Bangkok (TH); Sumittra CHAROJROCHKUL, Pathum Thani (TH); Pranuda JIVAGANONT, Pathum Thani (TH); Theerapron LEUNG ON, Pathum Thani (TH); Phontip TAMMAWAT, Pathum Thani (TH)

(73) Assignee: PTT Public Company Limited, Chatuchak, Bangkok (TH)

(21) Appl. No.: 16/300,487

(22) PCT Filed: Dec. 20, 2016
(86) PCT No.: PCT/TH2016/000099

§ 371 Date: Nov. 9, 2018

(30) Foreign Application Priority Data
Jul. 15, 2016 (TH) 1601004158

(51) Int. Cl. B01J 20/06; B01J 20/28; B01J 20/30; B01J 20/24; B01D 53/02

(52) U.S. Cl. CPC B01J 20/06; B01J 20/28004; B01J 20/2803; B01J 20/3007; B01J 20/3042; B01J 20/3064; B01D 2257/2025; B01J 20/24; B01D 53/02; B01J 20/28019; B01D 2253/1124; B01D 2253/304; B01D 2256/16; B01J 20/3078

(57) ABSTRACT

The present invention relates to a process of preparing a chloride adsorbent with natural binder wherein the organic binder is used to bind metal oxide powder altogether and polymethyl methacrylate (PMMA) or carbon black is used as porogen. The chloride adsorbent is then extruded, left at room temperature, dried and burned to form pores. The prepared adsorbent can efficiently remove the chloride compounds in both forms of inorganic chloride e.g. hydrogen chloride (HCI), organic chloride e.g. vinyl chloride (VCI) and trichloro ethylene (TCE) from the hydrogen stream generated from the continuous catalytic reforming unit, in the actual operation in the oil refinery and aromatic substance production facilities. The adsorbent prepared according to the present invention contains metal oxide of zinc in an amount of up to 99.5-99:8% by weight.

### TECHNICAL FIELD

The present invention relates to a metal oxide-based chloride adsorbent with natural binder and a process for preparing the metal oxide-based chloride adsorbent.

### BACKGROUND OF THE INVENTION

The continuous catalytic reforming unit is one of the operation units in oil refinery and aromatic substance production facilities. The catalyst used in such process will act efficiently once activated with organic chloride, resulting in hydrogen, which is the by-product of such cracking unit, containing residual chloride compound in forms of inorganic chloride e.g. hydrogen chloride (HCl); and organic chloride e.g. vinyl chloride (VC) and trichloroethylene (TCE).

The chloride compound in such hydrogen gas stream is not only corrosive; it also impairs the efficiency of the catalyst in the downstream process of the oil refinery and aromatic substance production facilities. Thus the chloride compound has to be removed prior to the use of hydrogen gas in other operation units in the downstream process.

The current method for removing chloride compound in the hydrogen gas stream generated from the continuous catalytic reforming unit in the oil refinery and aromatic substance production facilities uses an operation unit of the fix bed adsorption column type.

There are 3 types of chloride adsorbent commonly used in petroleum or petro-chemical industry: chloride adsorbent on alumina support, zeolite-based chloride adsorbent and a metal oxide-based chloride adsorbent.

The first chloride adsorbent is chloride adsorbent having alumina as support and metal group 1 (alkaline metal) or metal group 2 (alkaline earth metal) of the Periodic Table as active component which will reacts with the chloride compound in hydrogen gas and thereby forming solid chloride compound attached to the adsorbent's surface. Example applications of such adsorbent can be found in the disclosures of U.S. Pat. No. 4,639,259, U.S. Pat. No. 5,316,998, U.S. Pat. No. 5,505,926 U.S. Pat. No. 5,935,894, U.S. Pat. No. 6,013,600, U.S. Pat. No. 6,200,544 B1, U.S. Pat. No. 7,758,837 B2 and a publication of US patent application no. 20100222215 A1. The above-mentioned chloride adsorbent having alumina as support, although efficient in absorbing inorganic chloride, still has a drawback since the released organic chloride e.g. vinyl chloride, organic chloride can undergo Friedel-Crafts alkylation reaction and become organic chloride complex, which causes fouling. In certain cases, the organic chloride released from the absorption column containing this type of chloride adsorbent is usually more concentrated than the organic chloride in the inlet gas stream of the absorption column.

The second chloride adsorbent is zeolite-based chloride adsorbent which is widely used for removing organic chloride e.g. vinyl chloride. Example applications of such adsorbent can be found in the disclosures of U.S. Pat. No. 4,762,537, U.S. Pat. No. 6,632,766 B2 and U.S. Pat. No. 8,551,328 B2.

The third chloride adsorbent is one prepared by extruding metal oxide with inorganic binder. Examples of such adsorbent are disclosed in the following patent documents.

U.S. Pat. No. 3,935,295 discloses chloride adsorbent obtained from mixing zinc oxide with calcium oxide, using clay as binder.

U.S. Pat. No. 4,721,824 discloses chloride adsorbent obtained from molding magnesium oxide using clay, silica, alumina and silica-alumina as binder.

Chloride adsorbent prepared by molding metal oxide using inorganic binder is further disclosed in patent no. JP-B-52-35036, U.S. Pat. No. 4,861,578, U.S. Pat. No. 5,688,479, U.S. Pat. No. 6,432,374 B1, and U.S. Pat. No. 9,156,738 B2 and TH patent no. 20248.

In the aforementioned metal oxide-based chloride adsorbent, inorganic binder is used at different proportions varying 1-20% by weight. Such inorganic binder will remain in the components of the metal oxide-based chloride adsorbent when used in operation, thereby decreasing the amount of metal oxide in the adsorbent which will absorb chloride.

The above patent documents demonstrate the efforts in developing different adsorbents that could minimize the remaining chloride compound in the hydrogen stream generated from the continuous catalytic reforming unit in the o aromatic substance production facilities.

### SUMMARY OF THE INVENTION

The present invention relates to a process of preparing a metal oxide-based chloride adsorbent by extrusion using natural starch as organic binder and using program for maximizing the surface area of the adsorbent. The metal oxide-based chloride adsorbent, obtained from said process, wherein the natural starch and the porogen according to the present invention, is characterized in that it can be thermally degraded during the adsorbent preparation process. As a result, the metal oxide-based chloride adsorbent obtained from such process contains a higher quantitative proportion of metal oxide absorbing chloride.

The object of the present invention is to provide a process of preparing a metal oxide-based chloride adsorbent by extrusion using natural starch as organic binder and using porogen for maximizing the surface area of the adsorbent. Also provided is a metal oxide-based chloride adsorbent obtained from such process having a high quantitative proportion of metal oxide absorbing the chloride, especially for the case of the zinc oxide which is present in the chloride adsorbent prepared in an amount of up to 99.5 to 99.8% by weight. Such adsorbent is suitable for removing chloride compound in the hydrogen gas generated from the continuous catalytic reforming unit, which is one of the operations in an oil refinery and aromatic substance production facilities. The chloride adsorbent prepared according to the present invention has high chloride adsorption capacity as well as improved strength which will prevent breakage operation.

### DETAILED DESCRIPTION

The present invention relates to a process of preparing a metal oxide-based chloride adsorbent by extrusion using starch as organic binder. The metal oxide-based chloride adsorbent according to the present invention is capable of removing chloride in hydrogen gas stream generated from a continuous catalytic reforming unit, wherein the components of the used in the process of preparing a metal oxide-based chloride adsorbent according to the present invention comprise:
metal oxide powder having at least 99.5 wt % purity;
organic starch;
porogen; and
distilled water,
   wherein the process of preparing the metal oxide-based chloride adsorbent comprising the steps of:
mixing organic starch with distilled water at a controlled temperature of 75-85° C. to obtain a gel, preferably at 80° C.;
intimately mixing metal oxide powder and porogen with the gel to obtain a paste;
shaping the obtained paste by extrusion;
leaving the obtained product for 10-15 hours, preferably for 12 hours;
drying by heating at a temperature of about 80 to 120 ° C. for 0.5 to 3 hours at a heating rate of 2 to 4° C. per minute, in a further embodiment, preferably at the temperature of 100° C., for 1 hour at a heating rate of 3° C. per minute
“calcine to form pores” to increase porosity of the adsorbent, this step is carried out subsequent to the drying step, the temperature used ranging from 500 to 900° C. for 3 to 6 hours at a heating rate of 2 to 4° C. per minute. In a further embodiment, the preferred condition for the step of “calcine to form pores” is at the temperature of 800° C. for 4 hours at a heating rate of 3° C. per minute. Once finished pore forming by calcine, leaving the product is left to cool down to room temperature to obtain the metal oxide-based chloride adsorbent according to the present invention.

In the process of preparing a metal oxide-based chloride adsorbent according to the present invention, the proportion of the components used are as follows:
the first component of the present invention is metal oxide powder having at least 99.5 wt % purity present at a proportion of from 30 to 70% by weight;
the second component of the present invention is organic starch present at a proportion of from 3 to 20% by weight;
the third component of the present invention is porogen present at a proportion of no more than 0.01% by weight;
the fourth component of the present invention is distilled water present at a proportion of from 25 to 50% by weight.

Preferably, in the process of preparing a metal oxide-based chloride adsorbent according to the present invention, metal oxide powder is used, preferably, metal oxide of zinc.

Preferably, in the process of preparing a metal oxide-based chloride adsorbent according to the present invention, the metal oxide powder is smaller than 45 μm.

Preferably, in the process of preparing a metal oxide-based chloride adsorbent according to the present invention, the organic starch used is selected from glutinous rice starch, rice starch, cassava starch, corn starch or combinations of at least two of them.

Preferably, in the process of preparing a metal oxide-based chloride adsorbent according to the present invention, the porogen used is selected from polymethyl, methacrylate (PMMA) or carbon black.

Preferably, in the process of preparing a metal oxide-based chloride adsorbent according to the present invention, after the extrusion step, the paste product is of a cylindrical shape, preferably, a cylindrical shape having a diameter of 1-2 mm and a length of 3-4 mm.

Since the organic starch which is the binder and the porogen can be thermally degraded in the adsorbent preparation step of the above-mentioned process of preparing a metal oxide-based chloride adsorbent, the chloride adsorbent prepared according to the present invention consequently has high metal oxide, if zinc oxide is used, the amount of zinc oxide present in the chloride adsorbent will be as high as 99.5-99.8% by weight and capable of efficiently removing chloride compounds i.e. inorganic chloride e.g. hydrogen chloride and organic chloride e.g. vinyl chloride and trichloroethylene from the hydrogen stream in the operation of oil refinery and aromatic substance production facilities.

In a preferred embodiment, the metal oxide-based chloride adsorbent, obtained from the process of preparing a metal oxide-based chloride adsorbent according to the present invention, contain metal oxide of zinc in an amount of 99.5-99.8% by weight.

In a preferred embodiment, the metal oxide-based chloride adsorbent, obtained from the process of preparing a metal oxide-based chloride adsorbent according to the present invention, is of a cylindrical shape, preferably, the chloride adsorbent is of a cylindrical shape having a diameter of 1-2 mm and a length of 3-4 mm.

One or more embodiments of the present invention will be explained in more detail with reference to the following examples which, however, are not intended to limit the scope of one or more embodiments of the present invention.

### EXAMPLE 1

Organic starch was mixed with distilled water at the defined proportion, at a controlled temperature of 80° C. to form gel. Metal oxide of zinc and porogen were then added and intimately mixed until a paste is formed.

The obtained paste product was extruded into cylindrical shape, preferably of a diameter of 1-2 mm and a length of 3-4 mm, left for 12 hours, then “oven-dried” to remove the remaining water by heating at the temperature of 100° C. for 1 hour at a heating rate of 3° C. per minute. The paste product was then “calcined to form pores” to increase porosity of the adsorbent. This step was carried out subsequent to the oven-drying step by calcination at the temperature of 800° C. for 4 hours at a heating rate of 3° C. per minute. Once finished pore forming by calcination, the resulting product was left to cool down to room temperature to obtain the metal oxide-based chloride adsorbent according to the present invention.

### EXAMPLE 2

A commercial chloride adsorbent was used as a comparative example. Said adsorbent was chloride adsorbent on alumina support having the metal of group 1 of the Periodic Table i.e. sodium as active component.

### Metal Oxide-Based Chloride Adsorbent Performance Test

The metal oxide-based chloride adsorbents of Example 1 and Example 2 were tested under the following condition.

### Condition 1

The test under Condition 1 was carried out in the laboratory using a fix bed adsorption column having inorganic chloride therein i.e. the hydrogen chloride fed into the absorption column at a concentration in a range of 15-20 ppm, at a flow rate of 50 mL/minute, at a temperature of 25-28° C., a pressure of 1-2 bars. The height of all adsorbents contained in the absorption column was 10 cm. The column adsorbents were placed in 3 levels of the absorption column, each of which, in the order of upper to lower levels, has a height of 3, 3 and 4 cm. The inner diameter of the absorption column was 25.4 mm.

### Condition 2

The test under Condition 2 was carried out in the of the actual operation condition in the refinery and aromatic substance production facilities using fix bed adsorption column having hydrogen stream from the cracking unit of naphtha and the catalyst was passed at GHSV (Gas Hourly Space Velocity) 1400 hours⁻¹, a flow rate of 1 L per minute, at a temperature of 30-40° C., a pressure of 20-28 bars. The height of all adsorbents contained in the absorption column was 75 cm. The adsorbents were placed in 6 levels of the absorption column, each of which, in the order of upper to lower levels, has a height of 5, 5, 10, 20, 15 and 20 cm The inner diameter of the absorption column was 38 mm.

The chloride adsorbent tests were conducted in a continuous manner in both conditions above. The commercial chloride adsorbent was used as a comparative example. The concentration of the inorganic chloride e.g. hydrogen chloride and the organic chloride (for Condition 2) e.g. vinyl chloride gas and trichloroethylene gas was measure both at the inlet (initial concentration (Co) in part per million (ppm)) and the outlet (concentration at any time points (C) in ppm) of the absorption column. Throughout the test, in order to determine the breakthrough time (BT) which refers to the time at which the concentration of the chloride compound in the outlet gas exceeds 1 ppm which exceeds the acceptable value for oil refinery and aromatic substance production facilities.

Once the test was finished, the tested adsorbents were analyzed for the amount of the absorbed chloride, the Loss of Drying (LOD) of the tested adsorbent, and the crushing strength of the adsorbent.

The chloride adsorbent test was carried out in a continuous manner under the above-indicated condition in the laboratory. The chloride adsorbents according to the present invention (Example 1) and the comparative Example (Example 2) were tested in the presence of hydrogen chloride, fed into the absorption column (Co), having the concentration range of 5000 ppm. The results are shown in Table 1. The chloride adsorbent of Example 1 was found to have greater pre-test crushing strength and greater efficiency than Example 2 based on the fact that the chloride adsorbent of Example 1 has a higher percentage by weight of the absorbed chloride than Example 2. The breakthrough time of hydrogen chloride was also longer than Example 2.

TABLE 1

| Test Variables | Example 1 | Example 2 |
|---|---|---|
| Weight of the adsorbent in the absorption | 66.924 | 51.714 |
| column (g) | | |
| Volume of gas fed into the absorption column at | 3900 | 1200 |
| C/Co = 0.5 (L) | | |
| Concentration when contained in the absorption | 1.32 | 1.02 |
| column (g/cm³) | | |
| Absorbed chloride content (% by weight) | 31.7 | 15.2 |
| Pre-test crushing strength of the adsorbent (MPa) | 0.70 | 0.35 |
| Breakthrough time (BT) (hours) | 1010 | 384 |
| % usage of the adsorbent at breakthrough | 81% | 91% |
| time (BT) | | |

The chloride adsorbent test was carried out in the actual operation condition in the aromatic substance production facility e.g. for benzene, toluene, and xylene as mentioned above. The chloride adsorbents of Example 1 and Example 2 were tested at a fed hydrogen chloride concentration range of 10-20 ppm, and fed vinyl chloride gas concentration range of 0-5 ppm and a fed trichloroethylene gas concentration range of 2-10 ppm. The results are shown in Table 2. The chloride adsorbent of Example 1 was found to have a greater pre-test and post-test crushing strength as well as greater efficiency in absorbing chloride than Example 2 based on the fact that the absorbed chloride content of Example 1 was greater than that of Example 2. The breakthrough time of the three chloride gases i.e. hydrogen chloride gas, vinyl chloride gas, and trichloroethylene gas was also longer than that of Example 2.

TABLE 2

| Test Variables | Example 1 | Example 2 |
|---|---|---|
| Weight of the adsorbent in the absorption | 1158.36 | 709.94 |
| column (g) | | |
| Inlet chloride content fed into the absorption | 260.75 | 260.75 |
| column throughout the test (g) | | |
| Volume of gas fed into the absorption column | 462 | 462 |
| throughout the test (m³) | | |
| Density when contained in the absorption | 1.36 | 0.84 |
| column (g/m³) | | |
| Absorbed chloride content | 12.85 | 8.89 |
| (kg. chloride/m³ adsorbent) | | |
| Pre-test crushing strength of the adsorbent (MPa) | 0.70 | 0.35 |
| Post-test crushing strength of the adsorbent (MPa) | 0.41 | 0.08 |
| Breakthrough time of hydrogen chloride | 196 | 116 |
| gas (days) | | |
| Breakthrough time of vinyl chloride gas (days) | 160 | 90 |
| Breakthrough time of trichloroethylene gas (days) | 240 | 150 |
| Loss of Drying percentage of the | 10.63% | 17.44% |
| adsorbent (% LOD) | | |

What is claimed is:

1. A process of preparing a metal oxide-based chloride adsorbent with natural binder comprising the steps of:
mixing organic starch with distilled water at a controlled temperature of 75-85° C. to form gel;
mixing metal oxide powder and porogen with said gel till obtaining paste;
extruding said paste providing product;
residing said product at room temperature for 10-15 hours; and
heat drying said product at a temperature of 80 to 120° C. for 0.5 for 3 hours with heating rate of 2 to 4° C. per minute;
increasing a calcination temperature to 500 to 900° C. for 3 to 6 hours with heating rate of 2 to 4° C. per minute to form pores in said product; allowing it to cool down to room temperature after calcination, providing a metal oxide-based chloride adsorbent.

2. The process for preparing the metal oxide-based chloride adsorbent with natural binder according to claim 1, wherein a preferred ratio of the component is:
30-70 wt % of at least 99.5% pure metal oxide powder;
3-20 wt % of organic starch;
not more than 0.01 wt % of porogen; and
25-50 distilled water.

3. The process for preparing the metal oxide-based chloride adsorbent with natural binder according to claim 1 or 2, wherein the preferred metal oxide powder is zinc oxide powder.

4. The process for preparing the metal oxide-based chloride adsorbent with natural binder according any one of claims 1 to 3, wherein the metal oxide powder is smaller than 45 μm.

5. The process for preparing the metal oxide-based chloride adsorbent with natural binder according to any one of claims 1 to 4, wherein the organic starch is selected from glutinous rice starch, rice starch, cassava starch, corn starch or combinations of at least two of them.

6. The process for preparing the metal oxide-based chloride adsorbent with natural binder according to any one of claims 1 to 5, wherein the porogen is selected from polymethyl methacrylate (PMMA) or carbon black.

7. The process for preparing the metal oxide-based chloride adsorbent with natural binder according to any one of claims 1 to 6, wherein the extruded product has cylindrical shape.

8. The process for preparing the metal oxide-based chloride adsorbent with natural binder according to any one of claims 1 to 7, wherein the cylindrical extruded product has a diameter of 1-2 mm and a length of 3-4 mm.

9. The process for preparing the metal oxide-based chloride adsorbent with natural binder according to any one of claims 1 to 8, wherein the preferred controlled temperature at the step of mixing organic starch with distilled water is 80° C.

10. The process for preparing the metal oxide-based chloride adsorbent with natural binder according to any one of claims 1 to 9, wherein the preferred residing time at room temperature is 12 hours.

11. The process for preparing the metal oxide-based chloride adsorbent with natural binder according to any one of claims 1 to 10, wherein the preferred heat drying temperature is 100° C.

12. The process for preparing the metal oxide-based chloride adsorbent with natural binder according to any one of claims 1 to 11, wherein the preferred heat drying time is 1 hour.

13. The process for preparing the metal oxide-based chloride adsorbent with natural binder according to any one of claims 1 to 12 wherein, the preferred heating rate at heat drying step is 3° C. per minute.

14. The process for preparing a metal oxide-based chloride adsorbent with natural binder according to any one of claims 1 to 13 wherein the preferred calcination temperature is 800° C.

15. The process for preparing a metal oxide-based chloride adsorbent with natural binder according to any one of claims 1 to 14 wherein, the preferred calcination time is 4 hours.

16. The process for preparing a metal oxide-based chloride adsorbent with natural binder according to any one of claims 1 to 15, wherein the preferred heating rate at calcination step is 3° C. per minute.

17. A metal oxide-based chloride adsorbent obtained from the process of preparing the metal oxide-based chloride adsorbent with natural binder according to any one of claims 1 to 16.

18. The metal oxide-based chloride adsorbent according to claim 17, wherein an amount of the metal oxide, i.e. zinc oxide, is 99.5-99.8 wt %.

19. The metal oxide-based chloride adsorbent according to claim 17 or 18, wherein the metal oxide-based chloride adsorbent is of a cylindrical shape.

20. The metal oxide-based chloride adsorbent according to claim 17 or 18, wherein the metal oxide-based chloride adsorbent has a diameter of 1-2 mm and a length of 3-4 mm.
